(19) United States
(12) Patent Application Publication
(10) Pub. No.: US 2026/0267193 A1
(43) Pub. Date: Sep. 10, 2026

(54) ELECTRODE FOR ELECTROCHROMIC SYSTEM AND ELECTROCHROMIC SYSTEM CONTAINING SAID ELECTRODE

(71) Applicants: SAINT-GOBAIN GLASS FRANCE, COURBEVOIE (FR); CENTRE NATIONAL DE LA RECHERCHE SCIENTIFIQUE, PARIS (FR); COLLEGE DE FRANCE, PARIS (FR); SORBONNE UNIVERSITE, PARIS (FR)

(72) Inventors: Amaury PATISSIER, AUBERVILLIERS (FR); Simon REDOR, AUBERVILLIERS (FR); Gwenaëlle ROUSSE, PARIS (FR); Jean-Marie TARASCON, PARIS (FR)

(21) Appl. No.: 19/167,219

(22) PCT Filed: Mar. 18, 2024
(86) PCT No.: PCT/EP2024/057187

§ 371 Date: Sep. 19, 2025

(30) Foreign Application Priority Data
Mar. 20, 2023 (FR) FR2302568

(51) Int. Cl. G02F 1/155; E06B 9/24

(52) U.S. Cl. CPC G02F 1/155; E06B 9/24; E06B 2009/2464

(57) ABSTRACT

An electrode for an electrochromic device, includes an oxide of lithium, tungsten and nickel wherein the atomic ratio of nickel to tungsten is between 0.9 and 1.1, the oxide crystallizing in the orthorhombic system, the lithium, tungsten and nickel oxide corresponding to the formulation LiₓNi₂W₂O₉, with x between 0 and 2, limits included.

The present invention relates to the field of electrochemical devices with controllable optical and/or energetic properties, commonly referred to as “electrochromic devices”. More particularly, the invention relates to optical systems incorporating such electrochromic devices, and to associated manufacturing methods.

Electrochromic devices have certain features which can be modified under the effect of a suitable supply of power, between a clear state and a tinted state, most particularly transmission, absorption, reflection at certain wavelengths of electromagnetic radiation, especially in the visible and/or infrared range, or else light scattering. The transmission variation generally occurs in the optical field (infrared, visible, ultraviolet) and/or in other fields of electromagnetic radiation, hence why it is called a device with variable optical and/or energy properties, as the optical domain is not necessarily the only domain concerned.

From a thermal point of view, glazings whose absorption can be modified in at least one part of the solar spectrum make it possible to control solar gain inside rooms or passenger compartments/enclosed spaces when fitted as exterior glazings in buildings or windows in means of transport such as cars, trains or aircraft, and to prevent excessive heating of the latter in the event of strong sunlight.

Optically, they control the degree of vision, preventing glare when mounted in external glazings in case of bright sunlight. They can also have a particularly interesting shutter effect, both as exterior glazings and when used as interior glazings, for example to equip interior partitions between rooms (offices in a building), or to insulate compartments in trains or aircraft, for example.

Structurally, an electrochromic stack comprises two electrodes sandwiched between two transparent electroconductive layers. At least one of these electrodes comprises an electrochromic material which, by definition, is adapted to reversibly and simultaneously insert ions and electrons, the oxidation states corresponding to the inserted and deinserted states being of distinct coloration, one of the states exhibiting higher light transmission than the other. The insertion or deinsertion reaction is controlled by means of the two transparent conductive layers, the power supply of which is provided by a current generator or a voltage generator.

A first electrode, called the working electrode, is made of a cathodic electrochromic material adapted to capture ions when a voltage is applied across the terminals of the electrochromic system. The tinted state of the working electrode corresponds to its most reduced state.

This working electrode is associated with a second electrode, called anode counter-electrode, which is also capable of reversibly inserting cations, symmetrically with respect to the working electrode. In other words, this counter-electrode is thus adapted to yield ions when a voltage is applied across the electrochromic system. This counter-electrode consists of a layer that is preferably color-neutral, or at least only slightly colored when the working electrode is in the clear state, and preferentially has a coloration in the oxidized state so as to increase the overall contrast of the electrochromic stack between its tinted state and its clear state.

The working electrode and counter-electrode are separated by an interfacial region commonly referred to as the “electrolyte” (Ion-Conductor (IC)), which has the dual function of ion conductor and electrical insulator, although this may be optional. The ion conductor layer therefore prevents any short-circuit between the working electrode and the counter-electrode. It also allows both electrodes to retain a charge, thus maintaining their clear and tinted states.

According to a particular embodiment, such an electrolyte is formed by depositing a distinct intermediate layer between the working electrode and the counter-electrode. The boundaries between these three layers are defined by abrupt changes in composition and/or microstructure. Such electrochromic stacks therefore have at least three distinct layers separated by two distinct abrupt interfaces.

Alternatively, the working electrode and the counter-electrode are deposited one on top of the other and generally in contact with one another, and a transition region acting as an electrolyte is formed only subsequently, by migration of components within the electrodes during the manufacturing method and in particular during the stack heating phases.

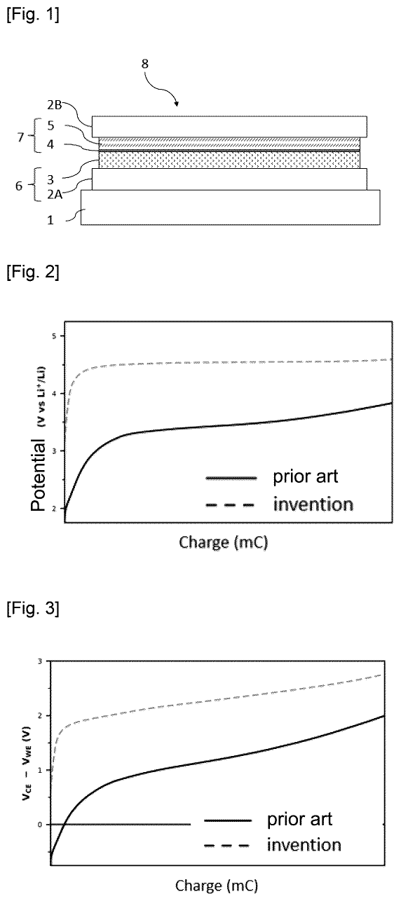

The two aforementioned conductive layers are arranged on either side of the electrodes, as shown in the attached FIG. 1.

The electrochromic device thus comprises two distinct sub-assemblies: a cathodic subassembly comprising the working electrode, and an anodic subassembly comprising the counter-electrode.

The choice of material for the counter-electrode is particularly important in electrochromic applications. It must, of course, be stable to successive charging and discharging cycles. The material must also have the highest possible Li+/Li potential. This high potential guarantees the system's efficiency. In particular, this increase in potential ultimately enables the electrochromic device as a whole to operate at a higher potential, thereby significantly reducing the time required to switch the device.

Application WO2014/143410 is known for an anode layer material comprising lithium, nickel and an element selected from tungsten (W) and molybdenum (Mo), wherein the atomic ratio (Mo+W)/(Mo+W+Ni) is between 0.025 and 1. The examples in this publication describe compounds with a Ni/W atomic ratio well in excess of 1. Electrodes obtained with such compounds, as reported in Table 3 of this publication, have a potential of between 2.88 and 3.56 V vs Li⁺/Li.

In particular, on a large electrochromic device, that is to say incorporating the electrochromic system described above on a large support (glazing), the switching speed is limited by the voltage drop along the surface of said device. This voltage drop is due to the limited conductivity of the materials making up the electrochromic system. Operating such an electrochromic device at a higher voltage reduces the impact of this voltage drop on the voltage distribution across the entire surface of the device, as a higher voltage results in a lower relative voltage drop at the center of the device. The device then switches more uniformly, and the final state is reached more quickly.

More particularly, in order to meet the objectives and problems previously described, the present invention relates to an electrode, in particular a counter-electrode, for an electrochromic device, comprising, preferably consisting of, an oxide of tungsten, nickel and optionally lithium, wherein the atomic ratio of nickel and tungsten is between 0.9 and 1.1, said oxide crystallizing in an orthorhombic reticular system.

Preferably, said electrode consists of no elements other than Li, Ni, W, and O, other than as unavoidable impurities.

According to preferred but non-limiting embodiments of the present invention, which can, very obviously, if appropriate, be combined with one another:
the atomic ratio of oxygen to nickel (O/Ni) in said oxide is between 4.0 and 5.0, in particular between 4.2 and 4.8.
the atomic ratio of oxygen to tungsten (O/W) in said oxide is between 4.0 and 5.0, in particular between 4.2 and 4.8.
said lithium, tungsten and nickel oxide corresponds to the formulation LixNi₂W₂O₉, with x between 0 and 2, limits included, preferably between 0 and 2, 0 excluded and 2 included.
x is between 0.1 and 2, limits included, preferably between 1 and 2, limits included.
said oxide crystallizes in the Pbcn space group.
said oxide has the following mesh parameters:

$$- a = 8.69 Å \pm 0.1 Å$$

$$- b = 5.06 Å \pm 0.1 Å$$

$$and$$

$$- c = 14.34 Å \pm 0.1 Å .$$

said oxide has a lamellar structure consisting of a succession of NiO₆ and WO₆ octahedral sheets, spaced apart by planes wherein lithium atoms are inserted, the distance between two nearest tungsten atoms belonging to two successive octahedral sheets preferably being greater than 3 Å, or even greater than 4 Å.

The invention also relates to an anode subassembly for an electrochromic system, said anode subassembly being adapted to be deposited on top of a glass-functioning substrate, comprising an electrode, in particular a counter-electrode, as previously described.

Said anode subassembly may in particular comprise:
a transparent conductive layer (2B),
a counter-electrode (5) consisting of an electrode as previously described and arranged above said first transparent conductive layer (2B).

In said anode subassembly, according to a first embodiment, said counter-electrode is in the form of a layer in contact with the transparent conductive layer.

According to another embodiment, the counter-electrode is in the form of a layer in contact with the transparent conductive layer, said layer consisting of crystallized particles of said nickel tungsten oxide dispersed in an organic or inorganic matrix.

The invention further relates to an electrochromic system incorporating a glass-functioning substrate, and comprising an electrode as previously described, in particular an anode subassembly as previously described.

An electrochromic system advantageously incorporates, from the surface of said substrate:
a cathode subassembly comprising a first transparent conductive layer and a working electrode;
an anode subassembly as above, in particular successively comprising a counter-electrode comprising said lithium, tungsten and nickel oxide, and a second transparent conductive layer arranged below said counter-electrode,
lithium (Li) ions introduced into said electrochromic system.

Preferably, the electrochromic system described above further comprises a distinct layer of an ionic conductor interposed between the electrode and the counter-electrode

In such an electrochromic system, said working electrode advantageously comprises a tungsten oxide, in particular WO₃, optionally doped with an element selected from Ni, Nb, Mo, Ta, Ti, V, Zn, Zr, or alternatively a vanadium oxide, in particular V₂O₅.

The thickness of the working electrode is typically between 100 and 1500 nm.

The thickness of the counter-electrode is generally between 100 and 1500 nm.

Lastly, the present invention relates to a glazing incorporating an electrochromic system as previously described, said glazing being suitable for use as a building glazing, in particular the exterior glazing of an internal partition or glass door, or as a glazing for the internal partitions or windows of means of transport such as trains, aircraft, cars or boats.

Such a glazing may comprise at least two glass substrates, incorporating the electrochemical system previously described.

Note that throughout the text, the deposition of one layer above or below another does not necessarily mean that these two layers are in direct contact with one another. The terms “above” and “below” refer here to the order in which these various elements are arranged, chosen arbitrarily with respect to the surface of the glass-functioning substrate. Alternatively, such an arrangement order can be reversed with respect to this same substrate. In addition, two layers deposited one on top of the other may, for example, be physically separated by one or more intermediate layers. In the same spirit, the term “between” does not necessarily mean that three designated elements are in direct contact with one another.

A glass-functioning substrate is of course a glass substrate, but also, alternatively, any rigid plastic material such as PMMA or polycarbonate that can support the electrochromic system in a glazing. Preferably, however, the substrate is made of glass.

According to preferential embodiments, the working electrode is deposited by magnetron. Alternatively, deposition is carried out using a liquid process.

According to a particular embodiment, said working electrode is at least composed of a Tungsten oxide (WOx) doped with at least one transition metal element Y selected from the group comprising Niobium (Nb), Molybdenum (Mo), Vanadium (Va), Tantalum (Ta), Titanium (Ti), Nickel (Ni), Zinc (Zn), Zirconium (Zr) as described in application WO2021/123267.

The invention also relates to an electrochromic system adapted to be deposited above a glass-functioning substrate, and comprising:
a cathode subassembly as described above,
a counter-electrode arranged above said cathode subassembly,
a second transparent conductive layer above said counter-electrode,
lithium (Li) ions introduced into said electrochromic system,
and preferentially a distinct layer of an ionic conductor interposed between the electrode and the counter-electrode.

The invention also relates to an electrochromic system adapted to be deposited above a glass-functioning substrate, and comprising:
a second transparent conductive layer arranged above said substrate,
a counter-electrode arranged above said second transparent conductive layer,
a cathode subassembly as described above, arranged above said counter-electrode,
lithium (Li) ions introduced into said electrochromic system,
and preferentially a distinct layer of an ionic conductor interposed between the electrode and the counter-electrode.

During manufacture of the electrochromic system, it is thus possible to reverse the order of deposition of the stack on the substrate, and thus alternately deposit the counter-electrode above the working electrode, or the working electrode above the counter-electrode.

Throughout the text, the step of introducing lithium (Li) ions into said electrochromic system can be carried out in various ways. Preferentially, one or more distinct lithium layers are interposed within the electrochromic system. The lithium ions are then caused to diffuse into the electrochromic stack, spontaneously and/or as a result of temperature rise.

According to a particular embodiment, said counter-electrode is at least composed of a Tungsten-Nickel oxide (NiWₓO_{z}), preferentially doped with at least one transition metal element.

According to one embodiment,
the thickness of the working electrode (3) is between 100 and 1500 nm, preferentially between 150 and 1000 nm, preferentially between 200 and 700 nm, preferentially between 300 and 500 nm, preferentially between 350 and 450 nm, and/or
the thickness of the counter-electrode (5) is between 100 and 1500 nm, preferentially between 150 and 500 nm, preferentially between 200 and 350 nm, preferentially between 225 and 300 nm, preferentially between 260 and 280 nm.

The invention also covers the obtainment of an electrochromic device by assembling a tempered cathode subassembly on the one hand, and an anode subassembly on the other. Such an anode subassembly comprises at least one counter-substrate on top of which a second transparent conductive layer and a counter-electrode are deposited. Preferentially, said anode subassembly is thermally tempered.

The invention also relates to a glazing incorporating such a tempering electrochromic system, said glazing being suitable for use as a building glazing, in particular the exterior glazing of an internal partition or glass door, or as a glazing for the internal partitions or windows of means of transport such as trains, aircraft, cars or boats.

Further features and advantages of the invention will become apparent from the following description of particular embodiments, given merely as illustrative and non-limiting examples, and the appended figures, for which:

FIG. 1 is a schematic depiction of an electrochromic system according to a particular embodiment of the invention,

FIG. 2 is a graph describing the potential of an electrode according to the invention comprising the crystallized compound LiₓNi₂W₂O₉, compared with that of an electrode according to the prior art WO2014/143410 and comprising the material LiₓNi_{y}WO_{z} with y>2

FIG. 3 is a graph wherein the potential difference between the counter-electrode and the working electrode is reported in an electrochromic device according to the invention as shown in FIG. 1, wherein the transparent conductive layers are made of ITO, the working electrode is made of WO₃ and the solid electrolyte layer is made of LiSiOₓ. The counter-electrode according to the invention comprises the crystallized compound LiₓNi₂W₂O₉ and that according to the prior art the material LiₓNi_{y}WO_{z} with y>2.

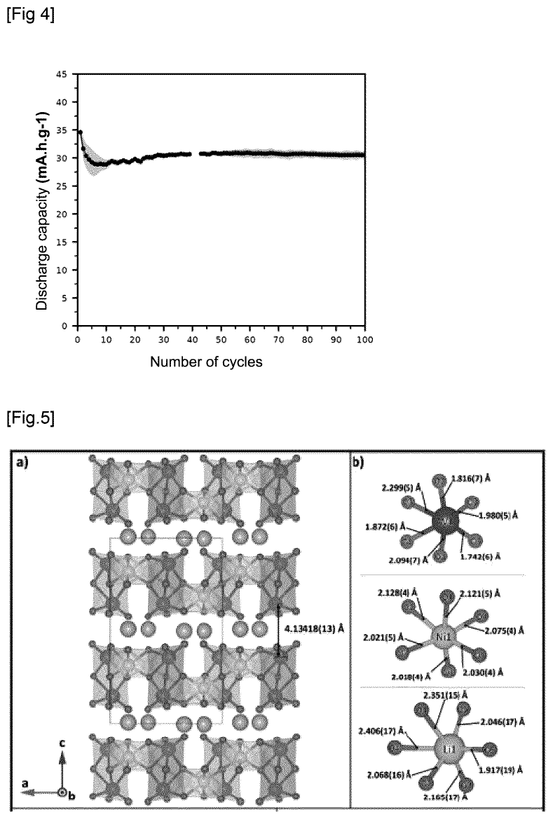

FIG. 4 shows the discharge capacity of the electrochemical system as successive charge and discharge cycles of an electrode according to the invention are performed.

FIG. 5 is a depiction of the structure of the LiₓNi₂W₂O₉ electrode material according to the invention as obtained by Rietveld analysis.

Unless otherwise indicated, the reference numbers used in FIG. 1 and reported in this description represent similar or identical elements.

The various elements illustrated in the figures are not necessarily shown to actual scale, the emphasis being more on representing the general operation of the invention.

Several particular embodiments of the invention are presented below. It is understood that the present invention is in no way limited by these particular embodiments, and that other embodiments are perfectly possible.

According to a particular embodiment, and as shown by FIG. 1, the invention relates to an electrochromic system (8) deposited on a glass-functioning substrate (1) and comprising, in their order of deposition: a first transparent conductive layer (2A), preferably made of indium-tin oxide (ITO), a working electrode (3) made of tungsten oxide (WOx) which can preferably be doped with an element chosen from Ni, Nb, Mo, Ta, Ti, V, Zn, Zr, an electrolyte (4), for example comprising or consisting of a lithium silicon oxide (LiSiOₓ), a counter-electrode (5) comprising or consisting of a lithium nickel tungsten oxide according to the invention of the general formulation LiₓNi₂W₂O₉, 0≤x≤2, and a second transparent conductive layer (2B) of indium tin oxide (ITO).

It should be noted that at this stage Lithium (Li) ions have already been introduced into said electrochromic system by depositing two distinct layers of Lithium, the first between the working electrode and the electrolyte, the second between the counter-electrode and the second transparent conductive layer, each deposit being followed by a heating step to cause diffusion of the Lithium ions into the electrochromic stack.

According to a preferred embodiment, at least some, and preferably all, of the layers forming the electrochromic stack are magnetron deposited. According to an alternative embodiment, at least some of these layers are deposited using an alternative method, such as liquid deposition.

In operation, the anode material of the electrode according to the invention (preferentially LiₓNi₂W₂O₉) is capable of exchanging lithium electrochemically. This lithium exchange is followed by a change in the material's oxidation state. In the reduced state (that is to say with maximum Li in the crystal lattice, e.g. x=2), the light absorbance of the material is minimal. In the oxidized state (that is to say with minimum Li in the crystal lattice, e.g. 1≤x<2), the optical absorbance of the material is maximum in the visible range. It is then referred to as anodic coloring. This color change could be due to the change in oxidation state of the nickel atoms: Ni²⁺/Ni³⁺, with Ni³⁺ species absorbing more visible light than Ni²⁺ species.

According to an alternative embodiment not shown, the order of deposition of the electrochromic stack on the substrate can be reversed, so that it is in the following order of deposition: a first transparent conductive layer (2A) made of indium-tin oxide (ITO), a counter-electrode (5) made of lithium nickel-tungsten oxide according to the invention, an electrolyte (4), for example comprising or consisting of a lithium silicon oxide such as LiSiOₓ, a working electrode (3) made of optionally doped tungsten oxide (WOx), and a second transparent conductive layer (2B) also made of indium-tin oxide (ITO). The working electrode is then deposited above the counter-electrode.

According to these two alternative embodiments, the first transparent conductive layer and the working electrode form a cathodic subassembly (6), while the counter-electrode and the second transparent conductive layer form an anodic subassembly (7).

A preferred electrochromic device according to the invention is therefore entirely solid, consisting of a stack of thin film layers on a transparent substrate (glass or plastic). At least 5 layers make up the stack
A first transparent conductive layer (ITO, SnO₂:F, etc.)
A working electrode layer (WO3, TiO2, V2O5, etc.)
An ionic conductor layer (LiSiOx, etc.)
A counter-electrode layer according to the invention
A second transparent conductive layer (ITO, SnO2:F, etc.).

Additional layers can be used:
Several layers of different compositions inside the working and counter-electrode layers.
Layers to improve optical properties (anti-reflective, etc.) between the substrate and other layers or at the air interface.
Encapsulation layer at the air interface
Buffer layers between electrodes and transparent conductive layers.

According to one possible alternative according to the invention, the electrochromic device can be built up from two transparent substrates (glass or plastic) on which at least 2 layers are deposited, constituting the component elements of said device.

The two component elements described above are joined together with the electrode and counter-electrode materials facing each other by means of an organic intermediate layer (polymer gel) which acts as an ionic conductor.

On the first substrate, at least the following layers are deposited:
a first transparent conductive layer (ITO, SnO₂:F, etc.)
a working electrode layer (e.g. WO₃, optionally doped, TiO₂, V₂O₅, etc.).

On the second substrate, the two deposited layers are at least:
A second transparent conductive layer (ITO, SnO₂:F, etc.)
A counter-electrode layer according to the present invention.

The interlayer gel can contain at least one polymer, a lithium salt, a solvent to dissolve the salt and a plasticizer for the polymer.

The experimental examples described below highlight some of the technical advantages conferred by an electrode according to the invention, without however limiting the scope of the claims.

The material according to the invention is synthesized as follows: Li₂Ni₂W₂O₉ powder is synthesized by ceramic synthesis from nickel oxide powder (NiO, Sigma-Aldrich, 99%), tungsten oxide (WO₃, Alfa Aesar, 99.8%), and lithium carbonate (Li₂CO₃, Sigma-Aldrich, ≥99.0%). The powders are mixed in an agate mortar before being transferred to a steel jar with two steel balls. The whole batch is inserted into a mechanical mill (SPEX SamplePrep 8000M Mixer/Mill) for 30 min of high-energy mechanical grinding.

The powder obtained is deposited in an alumina crucible and placed in a Carbolite CWF 1200 muffle furnace. The powder is heated in air at a rate of 5° C./min until it reaches 650° C., then kept in the furnace for 12 hours at this temperature to ensure decarbonation of the lithium carbonate. The powder is then annealed at 700° C. for 24 hours. The powder obtained is again mechanically ground for 30 min and kept at 700° C. for 24 hours to ensure complete reaction.

Galvanostatic charge-discharge experiments are first carried out using button cells obtained from the synthesized powder, in a two-electrode configuration. To measure the potential of an electrode comprising Li₂Ni₂W₂O₉ according to the invention, this is mixed with Super P carbon black (20% by weight), the other electrode consisting of lithium metal. An aluminum foil and a stainless steel plate were used as current collectors at the positive and negative electrodes, respectively. Two layers of Whatman GF/D glass fiber filters were used as separators between the two electrodes. The electrolyte was a 1 M solution of lithium hexafluorophosphate (LiPF6) in a 1:1:4 vol % mixture of ethylene carbonate (EC), propylene carbonate (PC) and dimethyl carbonate (DMC).

Measurements are made using a BioLogic BCS-805 battery cycler, and data acquired using EC-Lab. Cells are cycled between 2.5 and 5.0 V vs Li⁺/Li, at a current density of 10 mA·g⁻¹, at ambient temperature and pressure. Three button cells are cycled under the same conditions in order to verify the repeatability of electrochemical behavior and to obtain a certain statistical dispersion of these measurements.

For comparison, the same galvanostatic charge-discharge experiments are carried out in the same two-electrode configuration, but the potential of an electrode this time made of LiₓNi_{y}WO_{z} with y>2 is measured according to prior art WO2014/143410.

FIG. 2 shows the potentials (in V vs Li+/Li) of the electrode comprising the Li₂Ni₂W₂O₉ material according to the present invention (dotted line curve) and of the standard electrode previously described, based on the charge exchanged when the material changes from a clear state, that is to say one that absorbs little or no visible light (Li₂Ni₂W₂O₉), to a dark state, that is to say one that absorbs more, corresponding to the deinsertion of lithium ions and thus a Li₂₋ₓNi₂W₂O₉ formulation with x<2).

The results shown in FIG. 2 demonstrate an essential advantage of the present invention: an electrode comprising the Li₂Ni₂W₂O₉ material according to the present invention reacts at a very high potential compared to Li/Li+, in the range of 4.5 V to 5.0 V.

This property means that the electrochromic system according to the invention can be expected to be more effective. In particular, this increase in potential ultimately enables the electrochromic device as a whole to operate at a higher potential, thereby significantly reducing the time required to switch it.

An electrochromic device using the counter-electrode according to the invention is built on the model described above in relation to FIG. 1 and the same device but using an electrochromic device using the counter-electrode according to the prior art described above.

FIG. 3 shows the potential differences between the counter-electrode and the working electrode for an electrochromic system using either of the two counter-electrodes. It can be seen that the potential difference is much higher on a device according to the invention, which significantly reduces the time required to switch the system according to the invention.

FIG. 4 describes the discharge capacity of an electrode according to the invention as described above, as successive charging and discharging cycles take place. It can be seen that this capacity does not change during successive cycles, which guarantees the durability of said electrode in an electrochromic application.

X-ray diffraction and neutron diffraction analyses are carried out on the LiₓNi₂W₂O₉ oxide material. Its structure is determined from diffractograms using the Rietveld method. The material crystallizes in an orthorhombic lattice in the Pbcn space group, and its lattice parameters after refinement are a=8.69 Å; b=5.06 Å and c=14.34 Å.

The resulting oxide structure is shown in FIG. 5. A lamellar structure can be observed, comprising a succession of NiO₆ and WO₆ octahedral sheets along the c axis, spaced by planes wherein lithium atoms (ions) are inserted. According to the invention, the distance between the two closest tungsten atoms belonging to two successive octahedron sheets is of the order of 4.13 Å (see the attached FIG. 5)

In addition, X-ray diffraction shows that the oxide material also shows no structural changes with successive charge and discharge cycles.

Although particular embodiments of the present invention have been illustrated and described, it is obvious that various other changes and modifications may be made within the spirit and scope of the invention. The present text is therefore intended to cover in the appended claims all modifications that fall within the scope of the present invention.

1. An electrode for an electrochromic device, comprising an oxide of tungsten, nickel and optionally lithium, wherein an atomic ratio of nickel and tungsten (Ni/W) is between 0.9 and 1.1, said oxide belonging to the orthorhombic crystalline system.

2. The electrode according to claim 1, wherein the atomic ratio of oxygen to nickel (O/Ni) in said oxide is between 4.0 and 5.0.

3. The electrode according to claim 1, wherein the atomic ratio of oxygen to tungsten (O/W) in said oxide is between 4.0 and 5.0.

4. The electrode according to claim 1, wherein said lithium, tungsten and nickel oxide corresponds to the formulation LiₓNi₂W₂O₉, with x between 0 and 2, limits included.

5. The electrode according to claim 1, wherein x is between 1 and 2, limits included.

6. The electrode according to claim 1, wherein said oxide crystallizes in the Pbcn space group.

7. The electrode according to claim 1, wherein said oxide has the following mesh parameters:
$$a = 8.69 Å \pm 0.1 Å$$
$$b = 5.06 Å \pm 0.1 Å$$
$$and$$
$$c = 14.34 Å \pm 0.1 Å$$

8. The electrode according to claim 1, wherein said oxide has a lamellar structure consisting of a succession of NiO₆ and WO₆ octahedral sheets, spaced apart by planes wherein lithium atoms are inserted.

9. An anode subassembly for an electrochromic system, said anode subassembly being adapted to be deposited on top of a glass-functioning substrate, comprising an electrode as described according to claim 1.

10. The anode subassembly according to claim 9, comprising:
a transparent conductive layer,
a counter-electrode arranged above said first transparent conductive layer.

11. The anode subassembly according to claim 10, wherein said counter-electrode is in the form of a layer in contact with the transparent conductive layer.

12. The anode subassembly according to claim 10, wherein said counter-electrode is in the form of a layer in contact with the transparent conductive layer, said layer consisting of crystallized particles of said nickel tungsten oxide dispersed in an organic or inorganic matrix.

13. An electrochromic system incorporating a glass-functioning substrate and comprising an electrode according to claim 1.

14. The electrochromic system according to claim 13 incorporating, from a surface of said glass-functioning substrate:
a cathode subassembly comprising a first transparent conductive layer and a working electrode;
an anode subassembly,
lithium (Li) ions introduced into said electrochromic system.

15. The electrochromic system according to claim 13, further comprising a distinct layer of an ionic conductor interposed between the electrode and a counter-electrode.

16. The electrochromic system according to claim 13, wherein said working electrode comprises a tungsten oxide optionally doped with an element selected from Ni, Nb, Mo, Ta, Ti, V, Zn, Zr, or a vanadium oxide.

17. The electrochromic system according to claim 14, wherein a thickness of the working electrode is between 100 and 1500 nm.

18. The electrochromic system according to claim 14, comprising a counter-electrode and wherein a thickness of a counter-electrode is between 100 and 1500 nm.

19. A glazing incorporating an electrochromic system according to claim 13, said glazing being suitable for use as a building glazing or as a glazing for an internal partition or a window of a vehicle of transport.

20. The glazing according to claim 19, comprising at least two glass substrates, incorporating the electrochemical system.
